(19) United States
(12) Patent Application Publication
(10) Pub. No.: US 2016/0267086 A1
(43) Pub. Date: Sep. 15, 2016

(54) PRESENTING CONTENT ITEMS BASED ON RECEIVED FACET VALUE SCORES

(71) Applicant: Microsoft Technology Licensing, LLC, Redmond, WA (US)

(72) Inventor: Lars Hasso Liden, Seattle, WA (US)

(21) Appl. No.: 14/645,537

(22) Filed: Mar. 12, 2015

(51) Int. Cl. G06F 17/30

(52) U.S. Cl. CPC G06F 17/3053; G06F 17/30554

(57) ABSTRACT

In a content item feed, such as a news feed associated with a user in a social network, facet values for multiple facets are determined for the content items in the feed. These facets may include a topic or subject associated with the content item, an author of the content item, and the number of comments associated with the content item. After the user views the content item, the user is asked to score each of the facet values that were determined for the content item. After some number of content items have been scored by the user, newly received content items have their facet values automatically scored based on the scores received from the user for content items having some or all of the same facet values. The content items are displayed to the user according to the scores.

### BACKGROUND

Recent studies have shown that users are dissatisfied with the current state of the art in terms of social networks. Displayed posts or content items are reported as being irrelevant or a “waste of time” and that they demand too much attention. As a result, users may switch social networks, or may abandon social networking all together.

One source of dissatisfaction is the use of implicit measurements to prioritize content items or posts in a user's social network feed. Implicit measurements may include whether or not a link in a post was selected by the user, how long the user read the post, and whether or not the user viewed any comments associated with the post. Through these implicit measurements, the social network determines an order in which the content items are shown, and determines which content items are ultimately shown, or hidden, from the user. Though some explicit measurements are captured (such as likes and comments), these broad measurements are ineffective in capturing the nuanced reasons that a user may or may not like one content item more or less than another.

There are many drawbacks associated with reliance on implicit measurements. First, a user may choose to read or view a content item, but may ultimately determine that they did not like the content item. Yet because viewing a content item is a positive signal in an implicit measurement system, the user is likely to be provided similar content items in the future even though the user did not enjoy the content item. Second, implicit measurements often require a large amount of data with respect to a user actions to make meaningful recommendations, and such information may not be available for new users of the social network or for newly created social networks.

### SUMMARY

In a content item feed, such as a news feed associated with a user in a social network, facet values for multiple facets are determined for the content items in the feed. These facets may include a topic or subject associated with the content item, an author of the content item, and the number of comments associated with the content item, for example. After the user views the content item, the user has the option of scoring each of the facet values that were determined for the content item. Newly received content items have their facet values automatically scored based on the scores received from the user for content items having some or all of the same facet values. The content items are displayed to the user according to the scores. The user can later adjust the scores automatically given the facet values for a content item.

In an implementation, a content item feed is received. The content item feed includes a plurality of content items in a first order. For each content item in the content item feed, a facet value is determined for each of a plurality of facets associated with the content item. For each content item in a subset of the plurality of content items, a score is received for each facet value of the plurality of facets associated with the content item. For each content item of the plurality of content items that is not in the subset, a score is determined for each facet value of the plurality of facets associated with the content item that is not in the subset of content items based on the received scores. The content items are presented in a second order based on the scores for the facet values of the plurality of facets associated with each content item. The second order is different than the first order.

In an implementation, a plurality of content items are stored. Each stored content item is associated with a plurality of facets, each facet has a facet value, and each facet value is associated with a score. A content item is received. The content item is associated with metadata and is not in the stored plurality of content items. Based on the metadata associated with the received content item, a facet value is determined for each of the plurality of facets associated with the received content item. Content items of the stored plurality of content items that are associated with facets that have facet values that match any of the facet values are determined for the received content item. A score is determined for each facet value of the plurality of facets associated with the received content item based on the scores associated with the matching facet values of the determined content items of the stored plurality of content items. The received content item is stored along with the determined score for each of the facet values of the plurality of facets associated with the received content item by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for providing content items based on user feedback;

FIG. 2 is an illustration of an example content item provider;

FIG. 3 is an illustration of an example client device showing an example user interface;

FIG. 4 is an illustration of an example client device showing an example user interface;

FIG. 5 is an operational flow of an implementation of a method for presenting comment items;

FIG. 6 is an operational flow of an implementation of a method for determining scores for facet values associated with a received content item;

FIG. 7 is an operational flow of an implementation of a method for updating scores for facet values associated with a content item; and

FIG. 8 shows an exemplary computing environment in which example embodiments and aspects may be implemented.

### DETAILED DESCRIPTION

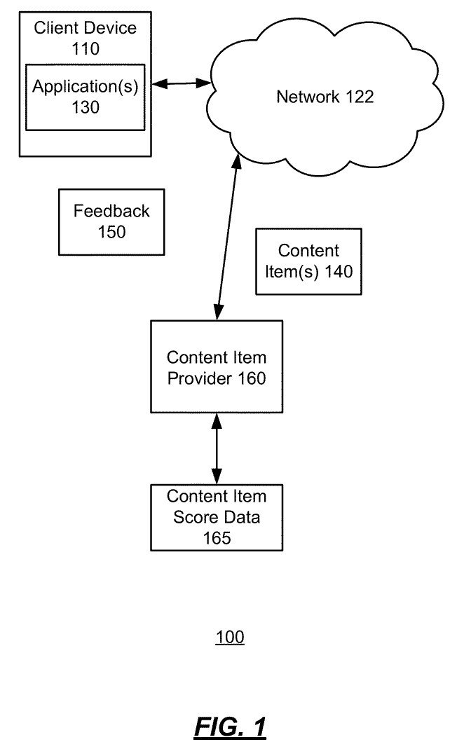

FIG. 1 is an illustration of an exemplary environment 100 for providing content items based on user feedback. The environment 100 may include a client device 110 and a content item provider 160 in communication through a network 122. The network 122 may be a variety of network types including the public switched telephone network (PSTN), a cellular telephone network, and a packet switched network (e.g., the Internet). Although only one client device 110 and content item provider 160 are shown in FIG. 1, there is no limit to the number of client devices 110 and content item providers 160 that may be supported.

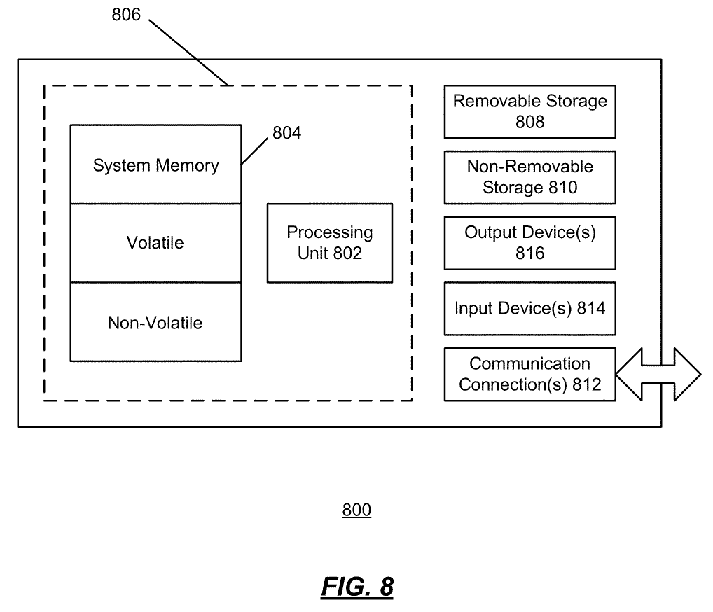

Both the client device 110 and the content item provider 160 may be implemented together or separately using a general purpose computing device such as is the computing device 800 described with respect to FIG. 8. The client device 110 may be a smart phone, video game console, laptop computer, set-top box, personal/digital video recorder, or any other type of computing device.

The content item provider 160 may provide one or more content items 140 to the client device 110. The content items 140 may be provided to the client device 110 as a feed or stream of content items. The content items 140 in the stream may be ordered based on a date and/or time associated with each content item 140. Alternatively or additionally, the content items 140 may be ordered based on implicit feedback or other information.

In some implementations, the content item provider 160 may be a social networking provider and the content items 140 may be posts made by users of the particular social network. In such an implementation, the content items 140 in the feed may be posts that are associated with a feed for a particular user of the social network.

Other types of content items 140 may be supported. For example, the content items 140 may be or comprise images, videos, articles, e-mails, documents, web pages, or any other type of content items that may be sent and received in a feed or stream.

The content items 140 may be associated with metadata. The metadata associated with a content item may include, but are not limited to, an author of the content item, a size or length of the content item, a creation date of the content item, a topic or subject of the content item, and a title of the content item. Where the content items 140 are posts in a social network, the metadata may include the number of comments or likes that are associated with the content item, a number of reshares or reposts associated with the content item, a geographic location of where the author was located when the content item was posted, and a social distance between the author of the content item and a user associated with the feed that the content item is part of, for example. Other types of metadata may be supported.

The client device 110 may execute one or more applications 130. The applications 130 may be a variety of application types including games, word processors, media viewers or renderers, or any other type of application that is capable of displaying, rendering, or processing a content item 140. Where the content item provider 160 is associated with a social network, the application 130 may be a web browser or an application designed to interact with the social network.

As described above, one drawback associated with social networks in particular, is that the content items 140 (i.e., posts) are typically presented to a user in an order that is based on a date or time associated with the content items 140 and implicit feedback that is based on observing how the user interacts with posts on the social network. This implicit feedback often misinterprets user behavior as positive feedback, which may lead to a user missing posts that they would otherwise have viewed, and may cause a negative user experience.

Accordingly, the application 130 may allow a user to provide feedback 150 with regard to content items 140 that are received and/or viewed by the user of the client device 110. The feedback 150 may be explicit feedback and may be scores that are assigned to particular aspects or characteristics of the content item 140 by the user. These aspects or characteristics are referred to herein as facets, and each facet may take one of a plurality of facet values. The values may be discrete values or may be ranges of values. Depending on the implementation, the facet values for a content item 140 may be determined by the content item provider 160 or application 130 based on the metadata associated with the content item 140 and/or the content of the content item 140.

For example, a content item 140 may be a post that is written by Joe, has received five comments, and has a picture of Joe's daughter. The facets and facet values that correspond to the content item 140 may be <Author> Joe </Author>, <Comments> Low </Comments>, <Type> Image </Type>, and <Subject> Family </Subject>. The facet values “Image” and “Joe” for the facets “Type” and “Author” may have been extracted from the metadata by the content item provider 160 and/or application 130 from the metadata associated with the content item 140. The facet value “Family” for the facet “Subject” may have been determined by the content item provider 160 and/or application 130 based on the text of the content item 140 by matching key words, or based on the associated picture using image recognition. The facet value “Low” for the facet “Comments” may have been determined by the content item provider 160 and/or application 130 by classifying the number of comments into the category low based on some predetermine thresholds that are based on the number of comments that a comment item 140 has received.

To generate the feedback 150, after a user has viewed a content item 140, the user may be asked, by either the application 130 or content item provider 160, to score each of the facet values associated with the content item 140. The scores may reflect the user's feelings about the overall importance of each facet value with respect to the user's enjoyment of the content item 140. Depending on the implementation, the user may be asked to score each facet value on a scale from 1 to 5, where 1 indicates that the particular facet value was very detrimental towards the user's enjoyment of the content item 140 and 5 indicates that the particular facet value was beneficial towards the user's enjoyment of the content item 140. The scores may be provided to the content item provider 160 as the feedback 150. The content item provider 160 may store the feedback 150 as the content item score data 165.

Continuing the example above, the user of the client device 110 may be presented with a user interface element that allows the user to enter scores for each facet value. The scores for each facet value may be initially left blank, may be set to a neutral initial value (e.g., 3), or may be set to an average of all the scores that have been received from the user for that particular facet value, for example, depending on the implementation. The user may be very good friends with “Joe”, and may give the facet value “Joe” a score of 5. The user may generally like to see images of children, and may give the facet values “Family” and “Image” scores of 4. The user may prefer to read posts that are popular and that have received a large number of comments, so the user may give the facet value “Low” for the facet “Comments” a score of 1.

The content item provider 160 and/or the application 130 may use the feedback 150 received from a user for a variety of content items 140 to order the content items 140 in the feed (e.g., present the highest scored content items 140 first), as well as to automatically generate feedback 150 for content items 140 that have not yet been scored by the user. For example, when a new content item 140 is generated with the facet value “Joe” for the facet “Author”, the content item provider 160 and/or application 130 may generate a score for the facet value “Joe” based on the scores that were provided by the user for content items 140 that also included the facet value “Joe” for the facet “Author”. The generated score may be the average of all of the scores provided by the user for the facet value “Joe”, may only include recent scores, or may be a weighted average that weights more recent scores higher than older scores. By considering the relative age of scores when computing the average scores, the content item provider 160 may be able to quickly adjust to the changing tastes or preferences of the user as reflected in their feedback 150.

The user of the client device 110 may customize how the content items 140 are presented to the user in the application 130 or by the content item provider 160. For example, the user may choose to view the content items 140 sorted by the associated scores, or may choose to view the content items 140 sorted by any of the facets, such as “Date”, “Author”, or “Comments.” Unlike traditional social networking applications where the content items 140 or posts continuously enter and leave the feed associated with the user regardless of whether the user has even decided whether or not to view them, in the system described herein, the content items 140 may persist until the user has either viewed them or has dismissed them. For example, the posts or content items 140 may be presented using a user interface similar to an e-mail application where the user may view unread posts or content items 140, or may delete posts or content items 140 that the user is not interested in viewing. By providing such a user interface, the user may be relieved of the pressure to continuously use the social networking application out of fear of missing an important post or content item 140.

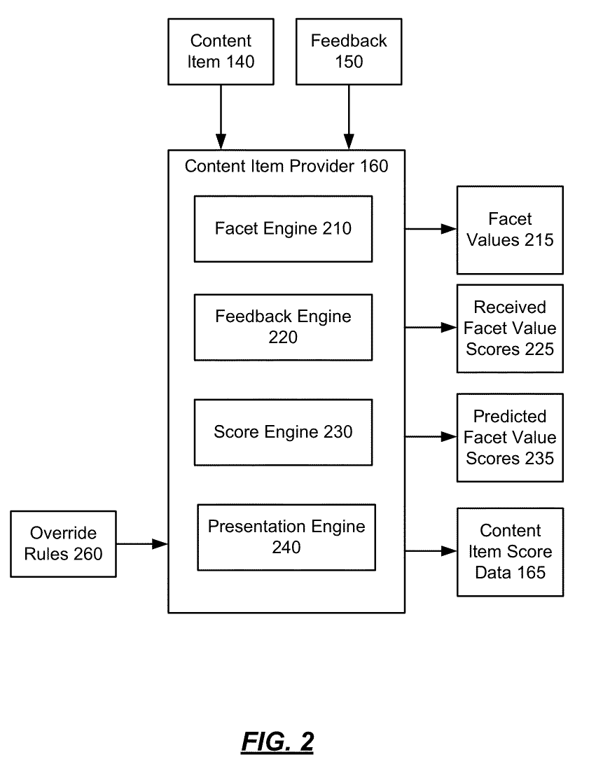

FIG. 2 is an illustration of an example content item provider 160. The content item provider 160 includes many components including, but not limited to, a facet engine 210, a feedback engine 220, a score engine 230, and a presentation engine 240. More or fewer components may be supported. Some or all of the components of the content item provider 160 may be implemented separately or together by a general purpose computing device such as the computing device 800 described with respect to FIG. 8. Moreover, while the components are shown as part of the content item provider 160, any of the components may be implemented by the application 130 of the client device 110.

The facet engine 210 may extract facet values from a received content item 140 for a plurality of facets. The particular facets used may be dependent on the type of content items 140 that are provided by the content item provider 160. For example, where the content items 140 are posts in a social network, the facets may include “Social Distance”, “Comments”, and “Likes.” Where the content items 140 are images, the facets may include “Image Size”, “F-stop”, and “Shutter Speed”. The particular facets used may be selected by a user or an administrator associated with a content item provider 160. While different types of content items 140 may use different sets of facets, each content item provider 160 may use the same set of facets for each content item 140 of the same type. For example, all posts in a social networking application may use the same set of facets.

The facet engine 210 may extract the facet values for each facet from the metadata associated with each content item 140. In addition, some facet values may be determined by the facet engine 210 by processing the content associated with the content item 140. For example, a facet value for a facet such as “Topic” or “Subject” may be determined by the facet engine 210 by searching the text of a content item 140 for certain key words or phrases. Any method known in the art for classifying data or text may be used.

In some implementations, the facet values may be determined based on information that is associated with the user who will view the content item 140. For example, there may be a facet “Distance” whose value represents a geographic or social distance between the author of the content item 140 and the user associated with the client device 110 that will view the content item 140. In such cases, the facet engine 210 may retrieve any additional information needed to determine facet values from the application 130 and/or the content item provider 160.

The facet engine 210 may store computed facet values as the facet values 215. The determined facet values 215 may be associated with the particular content item 140 that they were generated from, as well as the user that will view the content item 140.

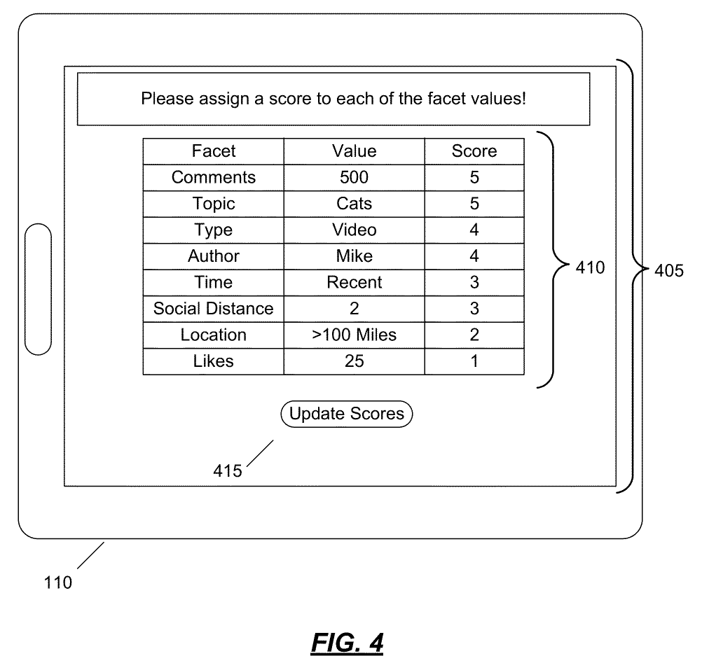

The feedback engine 220 may solicit feedback 150 from the user regarding content items 140 that the user has viewed. In some implementations, the feedback 150 may be received through a user interface that is presented to a user of the client device 110. The user interface may ask that the user provide a score for each of the facet values 215 determined for the content item 140 by the content item provider 160. An example user interface is illustrated in FIG. 4, for example.

The feedback engine 220 may store the received feedback 150 as the received facet value scores 225. The received facet value scores 225 may be associated with the particular content item that they were provided for, as well as the user that has viewed the content item. For content items 140 where no feedback 150 has been received, the feedback engine 220 may predict or guess the feedback 150 that the user would have provided for a content item based on the feedback 150 that the user provided for the other content items 140.

In some implementations, the feedback engine 220 may predict the score that a user would have given a facet value for a particular facet by using the scores that the user has given to the same facet value for the particular facet across some or all of the content items 140. For example, the predicted score for a facet value may be the average (mean, mode, or median) of all the scores given to the facet value by the user. Depending on the implementation, the predicted score may be weighted to favor more recent scores, or to remove scores that are older than a threshold age. Where not enough scores have been received for a particular facet value to make a prediction, a neutral score such as 3 may be used for the predicted score.

The feedback engine 220 may store the predicted scores as the predicted facet value scores 235. The predicted facet value scores 235 may be associated with the particular content item that they were provided for, as well as the user that will view the content item.

The score engine 230 may generate a score for a content item 140 for a user based on the received facet value scores 225 and predicted facet value scores 235 associated with the user and the content item 140. In some implementations, the score for a content item 140 for a user may be the sum or average of the received facet value scores 225 and predicted facet value scores 235 for the facet values of the content item 140. Optionally, the predicted and received scores may be weighted (or scaled) based on an importance assigned to each facet value by the user or an administrator.

In some implementations, the score engine 230 may also generate the scores for the content items 140 using one or more of what are referred to herein as “override rules” 260. An override rule 260 may identify one or more facet values for one or more facets that, when associated with a content item 140, results in a particular score for the content item regardless of the received facet value scores 225 and predicted facet value scores 235 that are associated with the content item.

For example, one example override rule 260 is that a content item 140 may receive a maximum score when the “Author” facet has a facet value of “Bob”. Another override rule 260 may be that a content item 140 may receive a maximum or minimum score when the “Topic” facet has a facet value of “Politics”. These override rules 260 may ensure that the user views or receives any content items 140 that are generated by Bob or that are related to Politics regardless of any of the other facet values associated with the content items 140.

Override rules 260 may also be based on combinations of facet values. For example, an override rule may be that when the “Author” facet has a facet value of “James” and the “Type” facet has a facet value of “Image” that the content item 140 may receive the maximum score. This override rule 260 would ensure that the user sees any posts by James that are pictures or images. In another example, an override rule may be that when the “Author” facet has a facet value of “Debbie” and the “Topic” facet does not have a facet value of “Politics” that the content item 140 may receive the maximum score. This override rule 260 would ensure that the user sees any posts by Debbie that are not about politics.

In some implementation, the override rules 260 may be provided by the user. For example, the user may provide one or more rules using a user interface similar to the user interface that the user used to provide scores for the facet values. Alternatively or additionally, the override rules 260 may be generated automatically by the application 130 and/or content Item provider 160. For example, if a particular facet value, or facet value combination, is often or mostly scored very highly by the user, then the content item provider 160 and/or application 130 may generate an override rule 260 based on the facet value. Any system or method for correlating facet scores may be used.

The score engine 230 may store the generated scores for the content items 140 as the content item score data 165. The content item scores in the content item score data 165 may be associated their particular content item, as well as the user that will view the content item.

The presentation engine 240 may present the content items 140 to the user in an order based on the generated content item scores. The content items 140 may be presented by the presentation engine 240 such that content items with high scores appear in the content item feed before content items with low scores. Alternatively, in some implementations, the user may select the ordering of content items 140 that they wish the presentation engine 240 to use. For example, the user may desire to view the content items 140 ordered by the facet “Author”, or the facet “Date”. Other ordering methods may be used. Depending on the implementation, only content items 140 that have not already been viewed by the user may be presented, or all content items 140 may be presented until explicitly marked or dismissed by the user.

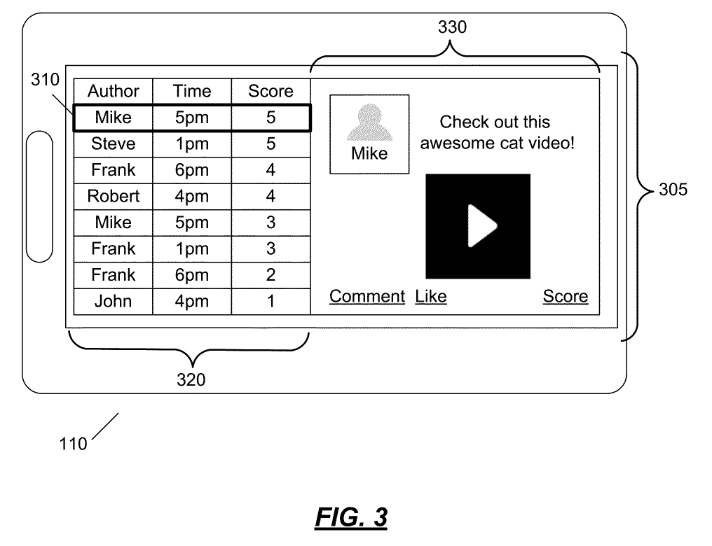

FIG. 3 is an illustration of an example client device 110 showing an example user interface 305. In the example shown, the client device 110 may be a tablet computer or a smart phone; however, other types of devices may be used. The client device 110 is displaying the user interface 305, through which a user is interacting with the content items 140 associated with the user's feed.

The user interface 305 includes a display region 320 and a display region 330. In the display region 320, a portion of the content items 140 that are part of the user's feed are displayed to the user. In the example shown, the content items 140 are identified to the user by the facets “Author, “Time”, and “Score”. The user may choose to view more or fewer facets in the display region 320.

The user may also choose the facet that is used to order the content items 140. In the example shown, the content items 140 are ordered by “Score” in the display region 320. However, the user may change the ordering by selecting the facet “Author” or the facet “Time”. Ordering by other facets may be supported by the user interface 305.

As shown by the box 310, the user has selected a content item 140 to view. Accordingly, the selected content item 140 is displayed to the user in the display region 330 of the user interface 305. The displayed content item 140 is written by Mike, has a time of 5 pm, and a score of “5”. The content item 140 is a video and is accompanied by the text “Check out this awesome cat video”. After selecting the content item 140, the user may view the video associated with the content item 140. The user may choose to leave a comment on the content item 140, or “like” the content item 140 by selecting one of the hyperlinks in the display area 330. In addition, the user may choose to score the content item 140 by selecting the “score” hyperlink.

FIG. 4 is an illustration of a user interface 405 that is display on the client device 110 after the user selected the “score” hyperlink from the user interface 305, or automatically after the user finished viewing the content item 140. As shown, some or all of the facets and facet values associated with content item are displayed to the user in a display area 410. The particular scores shown for the facet values may have been generated by the user on a previous occasion, or may be predictions that are based on the scores provided by the user for other content items 140.

The user may change the scores for some or all of the facet values in the user interface elements of the display area 410 that correspond to the facet values. After changing the scores, the user may submit the changes by selecting a user interface element 415 labeled “Update Scores”. The content item provider 160 may update the facet value scores for the content item 140 and the user in the content item score data 165. In addition, if the changes to the facet values scores affect the overall content item score for the content item 140, the content item provider 160 may update the content item feed 140 to reflect the changes.

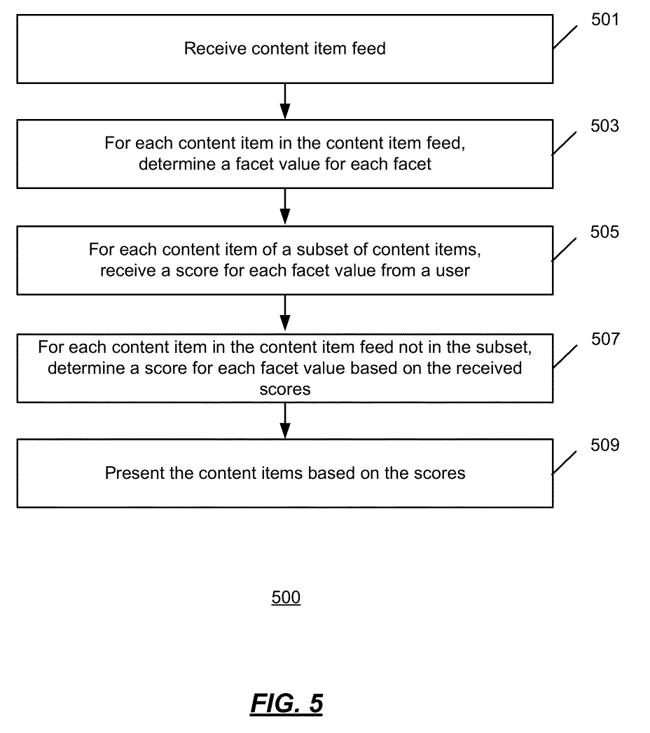

FIG. 5 is an operational flow of an implementation of a method 500 for presenting comment items. The method 500 may be implemented by the content item provider 160 and/or the application 130, for example.

At 501, a content item feed is received. The content item feed may be received by the content item provider 160. The content items 140 in the content item feed may include one or more of posts in a social networking application, video content items, images, posts on a message board, text messages, and documents. The content item feed may be a social networking feed for a user of the social networking application.

The content items 140 in the feed may be received in a first order. The order may be based on creation dates associated with each content item 140, or may be based on implicit feedback. Other methods for ordering content items 140 may be used.

At 503, for each content item in the content item feed, a facet value is determined for each of a plurality of facets. The facet values may be determined by the facet engine 210 of the content item provider 160. In some implementations, the facets values may be determined based on metadata associated with the content item 140. The metadata may include a variety of information about the content item such as the author of the content item, a size of the content item, a date of creating of the content item, a number of comments or likes associated with the content item, and a topic or subject of the content item. Other information may be included in the metadata.

At 505, for each content item in a subset of the content items, a score is received for each facet value from a user. The scores may be received by the feedback engine 220. The content items in the subset of content items may be those content items 140 that a user has taken the time to score the facet values associated with the content items 140. The score given to a facet value by a user may capture how important that particular facet value was to the overall enjoyment of the associated content item by the user. The received scores may be stored by the feedback engine 220 as the received facet value scores 225.

In some implementations, the feedback engine 220 may receive scores for each facet value associated with a content item by generating and presenting a user interface that includes, for each facet value, an indication of the facet value and a user interface element that is adapted to receive the score for the facet value. For example, the feedback engine 220 may generate and present a user interface such as the user interface 405, through which the user can enter scores for each of the displayed facet values through the various user interface elements displayed adjacent to their associated facet values.

At 507, for each content item from the content item feed that is not in the subset, a score for each facet value is determined based on the received scores. The determined score may be a score that the user is predicted to the give the facet value and may be determined by the feedback engine 220 using the received facet value scores 225. The determined scores may be stored by the feedback engine 220 as the predicted facet value scores 235.

In some implementations, the score for a facet value of a content item 140 may be determined based on an average score given by the user for the same facet value with respect to other content items 140. Depending on the implementation, the average may be a weighted average and may favor scores given to facet values of recently generated content items 140. Other methods for predicting a score or value may be used.

At 509, the content items may be presented based on the scores. The content items 140 may be presented by the presentation engine 240 based on both the received facet value scores 225 and the predicted facet value scores 235. The content items 140 may be presented in a second order that based on the facet scores and that is different than the first order.

In some implementations, the facet value scores associated with each content item may be used to determine a score for each content item. The score engine 230 may determine the score for a content item based on an average of all the scores of the facet values associated with the content item. The scores for the content items 140 may be stored as the content item score data 165. The presentation engine 240 may present the content items based on the determined content item scores.

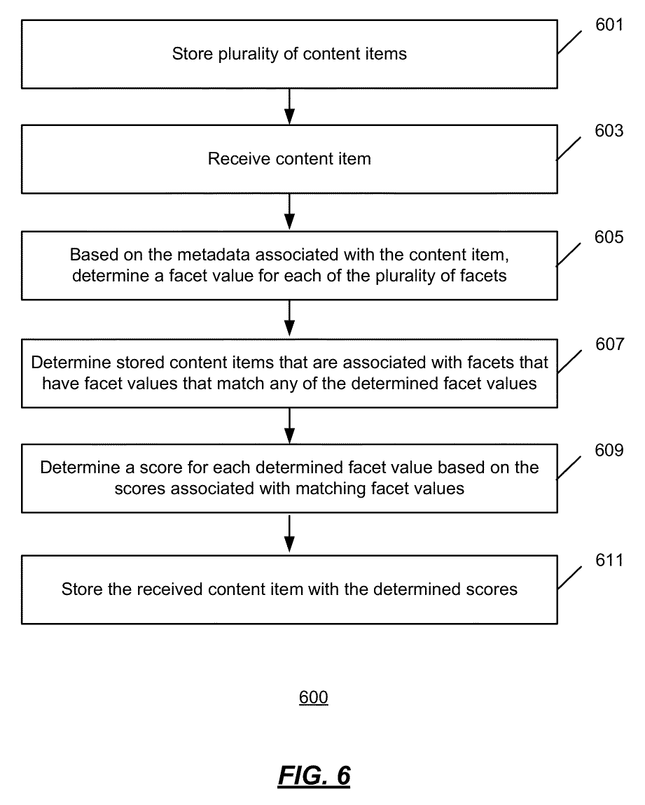

FIG. 6 is an operational flow of an implementation of a method 600 for determining scores for facet values associated with a received content item. The method 600 may be implemented by the content item provider 160 and/or the application 130, for example.

At 601, a plurality of content items are stored. The content items 140 may be stored by the content item provider 160. The content items 140 may be part of a content item 140 feed associated with a user. For example, the content item 140 feed may be a feed of a social networking application.

Each stored content item may be associated with a plurality of facets, with each facet having a facet value. In addition, each facet value may be associated with a score. The score associated with a facet value may have been provided by the user after the user viewed the content item. The score may represent how important the particular facet value is to the user.

At 603, a content item is received. The content item may be received by the content item provider 160. The content item may be associated with metadata. The content item may be a newly generated content item that the user has not yet viewed.

At 605, based on the metadata associated with the content item, a facet value is determined for each of the plurality of facets. The facet values may be determined by facet engine 210 by extracting the facet values from the metadata and/or the contents of the content item.

At 607, stored content items that are associated with facets that have facet values that match any of the determined facet values are determined. The stored content items may be determined by the feedback engine 220 of the content item provider 160.

At 609, a score is determined for each determined facet value based on the scores associated with the matching facet values of the determined content items 140. Each score may be determined by the feedback engine 220 of the content item provider 160. Each score determined for a determined facet value is a prediction of the score that the user would have given the facet value after viewing the content item. In some implementations, the determined score for a facet value is an average of all the scores provided by the user for the matching facet values.

At 611, the received content item is stored along with the determined facet values and the determined scores. The content item may be stored by the content item provider 160. At a later time, some or all of the stored content items may be provided to the user in an order that is based on the scores associated with the facet values.

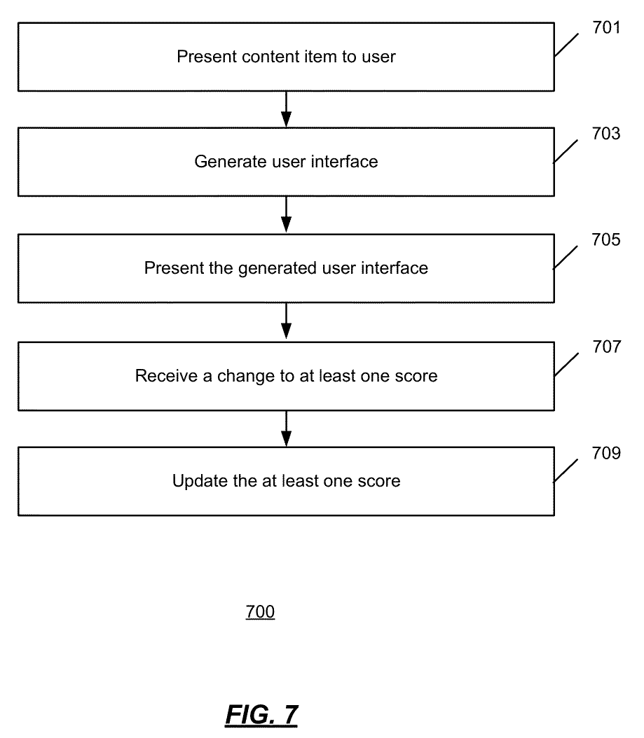

FIG. 7 is an operational flow of an implementation of a method 700 for updating scores for facet values associated with a content item. The method 700 may be implemented by the content item provider 160 and/or the application 130, for example.

At 701, a content item is presented to a user. The content item 140 may be presented to the user by the content item provider 160. In some implementations, the content item 140 may be a post in a social network. Other types of content items may be supported.

At 703, a user interface is generated. The user interface may be generated by the content item provider 160. An example of the user interface may be the user interface 410. The generated user inter-face may include each of the facet values associated with the content item along with a user interface element that may be used by the user to provide and/or modify a score for the each of the facet values.

At 705, the generated user interface is provided. The generated user interface may be provided and/or displayed to the user at the client device 110 by the content item provider 160.

At 707, a change to at least one score is received. The change may be received by the content item provider 160 from the provided user interface. For example, the user may increase or decrease at least one of the scores associated with the facet values using a user interface element of the provided user interface.

At 709, the at least one score is updated. The at least one score may be updated by the feedback engine 220 of the content item provider 160.

FIG. 8 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 800. In its most basic configuration, computing device 800 typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

Computing device 800 may have additional features/functionality. For example, computing device 800 may include additional storage (removable and/or non-removable) including, but not limited to, magnetic or optical disks or tape. Such additional storage is illustrated in FIG. 8 by removable storage 808 and non-removable storage 810.

Computing device 800 typically includes a variety of computer readable media. Computer readable media can be any available media that can be accessed by the device 800 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 800.

Computing device 800 may contain communication connection(s) 812 that allow the device to communicate with other devices. Computing device 800 may also have input device(s) 814 such as a keyboard, mouse, pen, voice input device, touch input device, etc. Output device(s) 816 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a content item feed by a computing device, wherein the content item feed includes a plurality of content items in a first order;
for each content item in the content item feed, determining a facet value for each of a plurality of facets associated with the content item by the computing device;
for each content item in a subset of the plurality of content items, receiving a score for each facet value of the plurality of facets associated with the content item by the computing device;
for each content item of the plurality of content items that is not in the subset, determining a score for each facet value of the plurality of facets associated with the content item that is not in the subset of content items based on the received scores by the computing device; and
presenting the content items in a second order based on the scores for the facet values of the plurality of facets associated with each content item by the computing device, wherein the second order is different than the first order.

2. The method of claim 1, wherein the content items comprises one or more of posts in a social networking application, video content items, images, posts on a message board, text messages, and documents.

3. The method of claim 1, wherein each content item is associated with metadata, and wherein determining a facet value for each of the plurality of facets comprises determining the facet value based on the metadata.

4. The method of claim 3, wherein the metadata comprises one or more of an author of the content item, a date and a time associated with the content item, a topic of the content item, a word count of the content item, a location of the author associated with the content item, a number of likes associated with the content item, and a number of comments made about the content item.

5. The method of claim 1, wherein the first order is a time based order.

6. The method of claim 1, wherein receiving a score for each facet value of the plurality of facets associated with the content item comprises:
generating a user interface that includes, for each facet of the plurality of facets, an indication of the facet value of the facet and a user interface element that is adapted to receive the score for the facet value;
presenting the user interface to a user; and
receiving the scores for the facet values through the user interface elements of the user interface.

7. The method of claim 1, wherein determining a score for each facet value of the plurality of facets associated with the content item that is not in the subset of content items based on the received scores comprises, for each facet value of the plurality of facet values associated with the content item:
determining content items of the subset of content items that are associated with a facet having the same facet value;
determining an average score for the facet value based on the score for the facet value from each of the determined content items; and
determining the score for the facet value for the content item based on the average score.

8. The method of claim 1, wherein presenting the content items in the second order based on the scores for the facet values of the plurality of facets associated with each content item comprises:
for each content item, determining a score for the content item based on the scores for the facet values of the plurality of facets associated with the content item; and
presenting the content items in the second order according to the scores determined for the content items.

9. The method of claim 8, wherein determining a score for the content item based on the scores for the facet values of the plurality of facets associated with the content item comprises:
determining that the content item includes a facet value for a facet that matches an override rule of a plurality of override rules; and
in response to the determination, determining the score for the content item based on the override rule.

10. The method of claim 9, wherein determining the score for the content item based on the override rule comprises giving the content item a maximum score or a minimum score.

11. A method comprising:
storing a plurality of content items by a computing device, wherein each content item is associated with a plurality of facets, each facet has a facet value, and each facet value is associated with a score;
receiving a content item by the computing device, wherein the content item is associated with metadata;
based on the metadata associated with the received content item, determining a facet value for each of the plurality of facets associated with the received content item by the computing device;
determining content items of the stored plurality of content items that are associated with facets that have facet values that match any of the facet values determined for the received content item by the computing device;
determining a score for each facet value of the plurality of facets associated with the received content item based on the scores associated with the matching facet values of the determined content items of the stored plurality of content items by the computing device; and
storing the received content item along the determined score for each of the facet values of the plurality of facets associated with the received content item by the computing device.

12. The method of claim 11, wherein the content items comprises one or more of posts in a social networking application, video content items, images, posts on a message board, text messages, and documents.

13. The method of claim 11, wherein the metadata comprises one or more of an author of the content item, a date and a time associated with the content item, a topic of the content item, a word count of the content item, a location of the author associated with the content item, a number of likes associated with the content item, and a number of comments made about the content item.

14. The method of claim 11, further comprising:
presenting the received content item to a user;
generating a user interface that includes, for each facet value of the plurality of facets associated with the received content item, a user interface element that is adapted to display the score determined for the facet value;
presenting the user interface to the user;
receiving a change to at least one of the determined scores through one of the user interface elements; and
in response to the received change, updating the at least one of the determined scores stored with the received content item.

15. The method of claim 14, wherein each of the stored content items is associated with the user.

16. The method of claim 11, wherein determining a score for each facet value of the plurality of facets associated with the received content item based on the scores associated with the matching facet values of the determined content items of the stored plurality of content items comprises, for each facet value of the plurality of facets associated with the received content item:
determining an average score based on the scores of the matching facet values of the determined content items of the stored plurality of content items; and
determining the score for the facet value of the received content item based on the determined average score.

17. A system comprising:
at least one computing device; and
a content item provider configured to:
receive a content item, wherein the content item is associated with metadata;
based on the metadata associated with the received content item, determine a facet value for each of a plurality of facets for the received content item;
determine content items of a stored plurality of content items that are associated with facets that have facet values that match any of the facet values determined for the received content item, wherein each matching facet value is associated with a score;
determine a score for each facet value of the plurality of facets associated with the received content item based on the scores associated with the matching facet values; and
present the received content item and the determined score for each facet value to a user.

18. The system of claim 17, wherein the content items comprises one or more of posts in a social networking application, video content items, images, posts on a message board, text messages, and documents.

19. The system of claim 17, wherein each of the stored content items is associated with the user.

20. The system of claim 17, wherein the content item provider is further configured to present the received content item and one or more of the stored plurality of content items to the user in an order that is based on the scores associated with the facet values of the stored plurality of content items and the determined scores for the facet values of the received content item.
